(19) United States
(12) Patent Application Publication
(10) Pub. No.: US 2025/0003530 A1
(43) Pub. Date: Jan. 2, 2025

(54) Tube comprising a pultruded cylindrical element

(71) Applicant: ARKEMA FRANCE, COLOMBES (FR)

(72) Inventors: Gilles HOCHSTETTER, Colombes Cedex (FR); Thibaut SAVART, Lacq (FR); Arthur BABEAU, Lacq (FR); Axel SALINIER, Lacq (FR)

(73) Assignee: ARKEMA FRANCE, COLOMBES (FR)

(21) Appl. No.: 18/292,805

(22) PCT Filed: Jul. 27, 2022
(86) PCT No.: PCT/FR2022/051515

§ 371 Date: Jan. 26, 2024

(30) Foreign Application Priority Data
Jul. 27, 2021 (FR) FR2108128

(51) Int. Cl. F16L 9/12; B29D 23/00; B29K 77/00; B29K 105/08; B29K 309/08

(52) U.S. Cl. CPC F16L 9/12; B29D 23/001; B29K 2077/00; B29K 2105/0872; B29K 2309/08

(57) ABSTRACT

A tube including at least one cylindrical element made of a pultruded fibrous material impregnated with a thermoplastic matrix, at least one additional fibrous reinforcement, partially or completely surrounding the cylindrical element(s), the fibers contained in the additional fibrous reinforcement being positioned along an axis different from the longitudinal axis of the cylindrical element, the total content of fibers of the tube being of between 40% and 70% by volume, with respect to the volume of the matrix and of the fibers contained in the tube.

The present invention relates to a tube comprising a pultruded cylindrical element. The invention also relates to its process of manufacture, and also to its use in structures, in particular in the field of mobility.

Lighter and stronger materials have been sought for many years. These materials can be used in the field in particular of transportation. In the field of aeronautics or motor vehicles, plastic or composite materials are tending to gradually replace metal parts, when this is possible.

In point of fact, the properties of lightness and of mechanical strength are not always reconcilable.

Furthermore, materials are sought which can bend easily, making it possible to avoid connectors between different parts. This ability to be bent reduces the number of parts to be used, and thus limits the costs, avoids possible leaks in the case of pipes for example, simplifies the implementation of the structure in its entirety, and makes it possible to maintain high mechanical performance qualities even in these bent zones.

Finally, from the viewpoint of environmental requirements, recyclable materials are sought.

There is thus sought a light, mechanically strong, tube which is relatively easy and simple to produce and to shape, and which may be able to be recycled.

The invention is targeted at a tube comprising:
at least one cylindrical element made of a pultruded fibrous material impregnated with a thermoplastic matrix,
at least one additional fibrous reinforcement, partially or completely, preferably completely, surrounding the cylindrical element(s),
the fibers contained in the additional fibrous reinforcement being positioned in an axis different from the longitudinal axis of the cylindrical element,
the total content of fibers of the tube being of between 40% and 70% by volume, with respect to the volumes of the matrix and of the fibers contained in the tube.

The invention also relates to a process for the manufacture of the tube as defined above, characterized in that it comprises the following successive stages:
a) pultrusion of the cylindrical element,
b) deposition of the additional fibrous reinforcement.

Finally, the invention relates to the use of the tube as defined above for forming structures, including in particular bicycle frames, reinforcements, battery pack reinforcements, vehicle chassis reinforcements.

It has been observed that the tube according to the invention is light. It exhibits excellent mechanical strength in flexion, in compression and in traction. In addition, it exhibits excellent properties for hot bending, making it possible to thus envisage varied shapes. In point of fact, this tube, deformed after bending and after possible reconsolidation in a closed mold, retains its mechanical strength properties.

### BRIEF DESCRIPTION OF THE FIGURES

FIG. 1 is a diagram illustrating the process of preparation of the tube according to the invention.

FIG. 2 is a diagram illustrating another process of preparation of the tube according to the invention.

### DETAILED DESCRIPTION OF THE INVENTION

Other characteristics, aspects, subject matters and advantages of the present invention will become even more clearly apparent on reading the description which follows.

It is specified that the expressions “from . . . to . . . ” and “of between . . . and . . . ” used in the present description should be understood as including each of the limits mentioned.

### Tube

The tube according to the invention comprises:
at least one cylindrical element made of a pultruded fibrous material impregnated with a thermoplastic matrix,
and
at least one additional fibrous reinforcement, partially or completely, preferably completely, surrounding the cylindrical element(s),
the fibers contained in the additional fibrous reinforcement being positioned in an axis different from the longitudinal axis of the cylindrical element,
the total content of fibers of the tube being of between 40% and 70% by volume, with respect to the volumes of the matrix and of the fibers contained in the tube.

The cylindrical element is manufactured according to a pultrusion process. It thus consists of fibers impregnated with a thermoplastic matrix. Pultrusion is a generally continuous process, which applies a traction of the fibers through a die in the axis of the cylindrical element, the fibers not necessarily being oriented in the axis of the traction. Pultrusion covers the impregnation of dry fibers, for example braids of dry fibers, fabrics of dry fibers or unidirectional rovings. It also covers the processing in the form of profiled elements of fibers which are coblended, of fibers which are preimpregnated, of braids which are preimpregnated with resin. According to the latter case, the fibers can be preimpregnated before the pultrusion stage.

According to one embodiment of the invention, in particular according to the application targeted, the tube according to the invention may contain a liner. However, this liner is not essential.

Within the meaning of the present invention, the term “tube” is understood to mean a hollow body having an unvarying section, of circular, square, rectangular, oval or other shape, preferably of circular shape.

### The Fibers

Concerning the constituent fibers of said fibrous material, these are in particular fibers of inorganic, organic or vegetable origin in the form of rovings.

Advantageously, the number of fibers per roving is, for carbon fibers, greater than or equal to 12K, greater than 24K, in particular greater than or equal to 50K, especially of from 24K to 36K.

Advantageously, the basis weight for the glass fiber is, per each roving, greater than or equal to 1200 tex, in particular less than or equal to 4800 tex, especially of from 1200 to 2400 tex.

Mention may be made, among the fibers of inorganic origin, of carbon fibers, glass fibers, basalt or basalt-based fibers, silica fibers or silicon carbide fibers, for example. Mention may be made, among the fibers of organic origin, of fibers based on thermoplastic or thermosetting polymer, such as semiaromatic polyamide fibers, aramid fibers or polyolefin fibers, for example. Preferably, they are based on amorphous thermoplastic polymer and exhibit a glass transition temperature Tg which is greater than the Tg of the constituent thermoplastic polymer or polymer blend of the impregnation matrix when the polymer or polymer blend is amorphous or greater than the M.p. of the constituent thermoplastic polymer or polymer blend of the impregnation matrix when the polymer or polymer blend is semicrystalline. Advantageously, they are based on semicrystalline thermoplastic polymer and exhibit a melting point M.p. which is greater than the Tg of the constituent thermoplastic polymer or polymer blend of the impregnation matrix when the polymer or polymer blend is amorphous or greater than the M.p. of the constituent thermoplastic polymer or polymer blend of the impregnation matrix when the polymer or polymer blend is semicrystalline. Thus, there is no risk of melting for the constituent organic fibers of the fibrous material during the impregnation by the thermoplastic matrix of the final composite. Mention may be made, among the fibers of vegetable origin, of natural fibers based on flax, hemp, lignin, bamboo, silk, in particular spider silk, sisal, and other cellulose fibers, in particular viscose fibers. These fibers of vegetable origin can be used pure, treated or else coated with a coating layer, for the purpose of facilitating the adhesion and the impregnation of the thermoplastic polymer matrix.

It can also correspond to fibers with support yarns.

These constituent fibers can be used alone or as mixtures. Thus, organic fibers can be mixed with inorganic fibers in order to be impregnated with thermoplastic polymer and to form the impregnated fibrous material.

The rovings of organic fibers can have several basis weights. In addition, they can exhibit several geometries.

The fibers are provided in the form of continuous fibers, which make up 2D fabrics, nonwovens (NCFs), braids or rovings of unidirectional (UD) fibers or nonwovens. The constituent fibers of the fibrous material can additionally be in the form of a mixture of these reinforcing fibers of various geometries. Preferably, the fibers included in the pultruded fibrous material of the cylindrical element are a braid of dry fibers.

Preferably, the fibrous material is chosen from glass fibers, carbon fibers, basalt fibers and basalt-based fibers. According to a first advantageous embodiment, the fibrous material is chosen from glass fibers. According to a second advantageous embodiment, the fibrous material is chosen from carbon fibers. According to a third advantageous embodiment, the fibrous material is chosen from basalt-based fibers.

Advantageously, the fibers are used in the form of a roving or of several rovings.

### The Thermoplastic Matrix

The term “thermoplastic” or “thermoplastic polymer” is understood to mean a material which is generally solid at ambient temperature, which can be semicrystalline or amorphous, and which softens during an increase in temperature, in particular after passing through its glass transition temperature (Tg), and flows at a higher temperature when it is amorphous, or which can exhibit obvious melting on passing through its “melting” point (M.p.) when it is semicrystalline, and which becomes solid again during a reduction in temperature below its crystallization point (for a semicrystalline polymer) and below its glass transition temperature (for an amorphous polymer).

The glass transition temperature, denoted Tg below, and the melting temperature, denoted M.p. below, are determined by differential scanning calorimetry (DSC) according to the standard ISO 11357-2:2013 and 11357-3:2013 respectively.

The thermoplastic polymer can be an amorphous polymer exhibiting a glass transition temperature Tg of greater than or equal to 50° C., in particular of greater than or equal to 100° C., especially of greater than or equal to 120° C., in particular of greater than or equal to 140° C., or a semicrystalline thermoplastic polymer, the melting point M.p. of which is greater than 150° C.

The matrix is described as “thermoplastic”, which means that the predominant component of the matrix is a thermoplastic polymer or else a blend of thermoplastic polymers.

Advantageously, said at least thermoplastic polymer is selected from: poly(aryl ether ketone)s (PAEKs), in particular poly(ether ether ketone) (PEEK); poly(aryl ether ketone ketone)s (PAEKKs), in particular poly(ether ketone ketone) (PEKK); aromatic polyetherimides (PEIs); polyaryl sulfones, in particular polyphenylene sulfones (PPSUs); polyaryl sulfides, in particular polyphenylene sulfides (PPSs); polyamides (PAs), in particular semiaromatic polyamides (polyphthalamides) optionally modified by urea units; PEBAs, the M.p. of which is greater than 150° C.; polyacrylates, in particular polymethyl methacrylate (PMMA); polyolefins, with the exclusion of polypropylene; polylactic acid (PLA); polyvinyl alcohol (PVA); fluoropolymers, in particular polyvinylidene fluoride (PVDF) or polytetrafluoroethylene (PTFE) or polychlorotrifluoroethylene (PCTFE); polyvinyl chloride (PVC) and acrylonitrile-butadiene-styrene (ABS) polymer and their blends, in particular a blend of PEKK and of PEI, preferably from 90-10% by weight to 60-40% by weight, in particular from 90-10% by weight to 70-30% by weight.

Advantageously, said at least thermoplastic polymer is selected from polyamides, aliphatic polyamides, cycloaliphatic polyamides and semiaromatic polyamides (polyphthalamides), PEKK, PEI and a blend of PEKK and of PEI.

The nomenclature used to define the polyamides is described in the standard NF EN ISO 1874-1:2011, “Plastics—Polyamide (PA) Moulding and Extrusion Materials—Part 1: Designation”, in particular on page 3 (Tables 1 and 2), and is well known to a person skilled in the art.

The polyamide can be a homopolyamide or a copolyamide or a blend of these.

For tubes which have to withstand high temperatures, use is advantageously made according to the invention of poly(aryl ether ketone)s PAEKs, such as poly(ether ketone)s PEKs, poly(ether ether ketone) PEEK, poly(ether ketone ketone) PEKK, poly(ether ketone ether ketone ketone) (PEKEKK) or PAs having a high glass transition temperature Tg.

Advantageously, said polyamide is chosen from aliphatic polyamides, cycloaliphatic polyamides and semiaromatic polyamides (polyphthalamides).

Advantageously, the aliphatic polyamide is chosen from polyamide 6 (PA6), polyamide 11 (PA11), polyamide 12 (PA12), polyamide 66 (PA66), polyamide 46 (PA46), polyamide 610 (PA610), polyamide 612 (PA612), polyamide 1010 (PA1010), polyamide 1012 (PA1012), polyamide 11/1010 (PA11/1010) and polyamide 12/1010 (PA12/1010), or a blend of these or a copolyamide of these, and block copolymers, in particular polyamide/polyether (PEBA) copolymers, and the semiaromatic polyamide is a semiaromatic polyamide optionally modified by urea units, in particular a PA MXD6 and a PA MXD10, or a semiaromatic polyamide of formula X/YAr, as described in EP 1505 099, in particular a semiaromatic polyamide of formula A/XT in which:
A is chosen from a unit obtained from an amino acid, a unit obtained from a lactam and a unit corresponding to the formula (Ca diamine)·(Cb diacid), with a representing the number of carbon atoms of the diamine and b representing the number of carbon atoms of the diacid, a and b each being of between 4 and 36, advantageously between 9 and 18, the (Ca diamine) unit being chosen from linear or branched aliphatic diamines, cycloaliphatic diamines and alkylaromatic diamines and the (Cb diacid) unit being chosen from linear or branched aliphatic diacids, cycloaliphatic diacids and aromatic diacids;
XT denotes a unit obtained from the polycondensation of a Cx diamine and of terephthalic acid (T), with x representing the number of carbon atoms of the Cx diamine, x being of between 6 and 36, advantageously between 9 and 18. Advantageously, a semiaromatic polyamide is of formula A/6T, A/9T, A/10T or A/11T, A being as defined above, in particular a polyamide PA 6/6T, a PA 66/6T, a PA 6I/6T, a PA MPMDT/6T, a PA 11/10T, a PA 11/6T/10T, a PA MXDT/10T, a PA MPMDT/10T, a PA BACT/10T, a PA BACT/6T, a PA BACT/10T/6T or a PA 11/BACT/10T; T corresponds to terephthalic acid, MXD corresponds to m-xylylenediamine, MPMD corresponds to methylpentamethylenediamine and BAC corresponds to bis(aminomethyl)cyclohexane.

Advantageously, said thermoplastic polymer is a semicrystalline polymer.

Advantageously, said semicrystalline polymer exhibits a glass transition temperature such that Tg≥80° C., in particular Tg≥100° C., especially ≥120° C., in particular ≥140° C., and an M.p. ≥150° C.

In the latter case, said at least semicrystalline thermoplastic polymer is selected from: poly(aryl ether ketone)s (PAEKs), in particular poly(ether ether ketone) (PEEK); poly(aryl ether ketone ketone)s (PAEKKs), in particular poly(ether ketone ketone) (PEKK); aromatic polyetherimides (PEIs); polyaryl sulfones, in particular polyphenylene sulfones (PPSUs); polyaryl sulfides, in particular polyphenylene sulfides (PPSs); polyamides (PAs), in particular semiaromatic polyamides (polyphthalamides) optionally modified by urea units; polyacrylates, in particular polymethyl methacrylate (PMMA); polyolefins, with the exclusion of polypropylene; polylactic acid (PLA); polyvinyl alcohol (PVA); polyvinyl chloride (PVC) and acrylonitrile-butadiene-styrene (ABS) polymer; and their blends, in particular a blend of PEKK and of PEI, preferably from 90-10% by weight to 60-40% by weight, in particular from 90-10% by weight to 70-30% by weight.

More advantageously, in the latter case, said at least thermoplastic polymer is selected from polyamides, aliphatic polyamides, cycloaliphatic polyamides and semiaromatic polyamides (polyphthalamides), PEKK, PEI and a blend of PEKK and of PEI.

### The Impregnated Fibrous Material

In the impregnated materials, also referred to as “ready for use” materials, the impregnating thermoplastic polymer or blend of thermoplastic polymers is distributed uniformly and homogeneously around the fibers. In this type of material, the impregnating thermoplastic polymer must be distributed as homogeneously as possible within the fibers in order to obtain a minimum of porosities, that is to say a minimum of voids between the fibers. Specifically, the presence of porosities in materials of this type can act as points of concentrations of stresses, for example during placing under mechanical tensile stress, and which then form points of initiation of failure of the impregnated fibrous material and mechanically weaken it. A homogeneous distribution of the polymer or blend of polymers thus improves the mechanical strength and the homogeneity of the composite material formed from these impregnated fibrous materials.

Advantageously, the content of fibers in said impregnated fibrous material is of from 45% to 70% by volume, preferably from 50% to 70% by volume, preferably from 50% to 60% by volume, in particular from 54% to 60% by volume, with respect to the volume of the impregnated fibrous material.

The measurement of the content of fibers can be carried out by image analysis (use of microscope or of camera or of digital camera, in particular) of a cross section of the tube, by dividing the surface area of the fibers by the surface area of the tube (impregnated surface area plus surface area of the porosities). In order to obtain a good quality image, it is preferable to coat the tube, cut across its transverse direction, in a standard polishing resin and to polish with a standard protocol making possible the observation of the sample with a microscope at at least six times magnification. The image size to be analyzed is between 10-12 times the diameter of the fiber. Between 5 and 40 images at different locations (sections) are taken. The mean is taken over all the images and recalculated by volume.

For the measurement of the content of fibers in the part of the additional fibrous reinforcement, if this is a fibrous material based on continuous fibers impregnated with a thermoplastic matrix, the same measurement is made but on a section perpendicular to the direction of the fibers of the additional fibrous reinforcement.

If the fibers are carbon fibers, the measurement of the content of carbon fibers can be determined according to ISO 14127:2008.

If the fibers are glass fibers, the measurement of the content of fibers is determined according to ISO 1172:1999.

Advantageously, the degree of porosity of said impregnated fibrous material is less than 10%, in particular less than 5%, especially less than 2%.

It should be noted that a degree of porosity of zero is difficult to achieve and that consequently, advantageously, the degree of porosity is greater than 0% but less than the abovementioned degrees.

The degree of porosity corresponds to the degree of closed porosity and can be determined either by electron microscopy, or as being the relative deviation between the theoretical density and the experimental density of said impregnated fibrous material as described in the examples part of EP 3 418 323, in particular example 4.

The composite material is leaktight, inert and resistant.

Preferably, the tube according to the invention comprises fibrous materials comprising, as fibers, fibers chosen from glass fibers, carbon fibers, basalt fibers and basalt-based fibers and, as thermoplastic matrix, polymers chosen from polyamides, aliphatic polyamides, cycloaliphatic polyamides, semiaromatic polyamides (polyphthalamides), PEKKs, PEIs and a blend of PEKK and of PEI.

The impregnated fibrous material is thus manufactured by pultrusion in the form of a cylinder.

According to one embodiment, the internal diameter of the cylindrical element can be of between 10 mm and 100 mm, preferably between 15 mm and 50 mm.

The length of the tube can be of between 10 cm and 1 m, preferably between 15 cm and 50 cm.

During the manufacture of the tube, the manufacturing process is a continuous process, which results in tubes which can range from 50 cm to 3 m in length, depending on the size of the production site. These tubes can subsequently be reworked and shortened, so as to be suitable for the targeted application. Thus, the final tube, that is to say ready for use, is generally less than 1 m and can range from 15 cm to 50 cm.

A person skilled in the art will know how to adapt the dimensions of the cylindrical element according to the destination of the tube.

According to another embodiment, the ratio of the thickness of the wall of the tube to its internal diameter can be less than 0.20, preferably less than 0.10.

### Additional Fibrous Reinforcement

The tube according to the invention also comprises at least one additional fibrous reinforcement, partially or completely, preferably completely, surrounding the cylindrical element(s).

Within the meaning of the present invention, the term “fibrous reinforcement” is understood to mean a material comprising fibers which confers a greater mechanical strength on the final part.

The additional fibrous reinforcement is chosen from dry continuous fibers, a fibrous material based on continuous fibers impregnated with a thermoplastic matrix, and their mixture.

When the additional fibrous reinforcement is dry fibers, the latter can be chosen from those defined above.

When the additional fibrous reinforcement is a fibrous material based on continuous fibers impregnated with a thermoplastic matrix, it can be identical to or different from the fibrous material constituting the cylindrical element.

When the additional fibrous reinforcement is a fibrous material based on continuous fibers impregnated with a thermoplastic matrix, the total content of fibers of the tank, which is of between 40% and 70% by volume, with respect to the volumes of the matrix and of the fibers contained in the tube, takes into account the matrix of the pultruded thermoplastic-impregnated fibrous material and the matrix of the additional fibrous reinforcement. In other words, the total content of fibers of the tank is of between 40% and 70% by volume, with respect to the volumes of the matrices and fibers contained in the tube.

According to one embodiment, the additional fibrous reinforcement is chosen from a braid of dry fibers, a braid of fibrous tapes impregnated with thermoplastic resin, and their mixture.

Thus, according to a first embodiment, the fibers included in the fibrous material can be a braid of dry fibers and the additional fibrous reinforcement can also be a braid of dry fibers.

According to a second embodiment, the fibers included in the fibrous material can be rovings of continuous fibers and the additional fibrous reinforcement can also be a braid of dry fibers.

According to a third embodiment, the fibers included in the fibrous material can be a braid of fibers and the additional fibrous reinforcement can also be rovings of continuous fibers.

According to a fourth embodiment, the fibers included in the fibrous material can be a braid of fibers and the additional fibrous reinforcement can also be rovings of continuous fibers which are impregnated.

According to a fifth embodiment, the fibers included in the fibrous material can be rovings of continuous fibers and the additional fibrous reinforcement can also be rovings of continuous fibers which are impregnated.

The thermoplastic matrix of the additional fibrous reinforcement can be identical to or different from that of the cylindrical element. Preferably, the thermoplastic matrix of the cylindrical element is completely or partially miscible with the thermoplastic matrix of the additional fibrous reinforcement. This complete or partial miscibility makes it possible to increase the adhesion between the wall of the cylindrical element and the layer of the additional fibrous reinforcement.

According to a particular embodiment of the invention, the tube can comprise a cylindrical element, the thermoplastic matrix of which is made of PVC, and a fibrous reinforcement, the polymeric matrix of which is made of acrylic.

According to another particular embodiment of the invention, the tube can comprise a cylindrical element, the thermoplastic matrix of which is made of ABS, and a fibrous reinforcement, the polymeric matrix of which is made of acrylic.

According to yet another particular embodiment of the invention, the tube can comprise a cylindrical element, the thermoplastic matrix of which is made of polyamide, and a fibrous reinforcement, the polymeric matrix of which is made of polyphthalamide.

Preferably, the thermoplastic matrix of the additional fibrous reinforcement exhibits a melting point of greater than 150° C.

Preferably, the thermoplastic matrix of the additional fibrous reinforcement exhibits a glass transition temperature of greater than 80° C., preferably of greater than 100° C. and more particularly of greater than 120° C.

More particularly, the thermoplastic matrix of the additional fibrous reinforcement exhibits a melting point of greater than 150° C. and a glass transition temperature of greater than 80° C., preferably of greater than 100° C. and more particularly of greater than 120° C.

The thickness of the layer of the fibrous reinforcement can be of between 0.5 mm and 10 mm, preferably between 0.5 mm and 5 mm.

The total content of fibers is of between 40% and 70% by volume, with respect to the sum of the volume of the matrix and of the fibers, preferably between 50% and 70% by volume.

Within the meaning of the present invention, the term “the total content of fibers” is understood to mean the sum of the content of fibers contained in the tube, that is to say in the cylindrical element and in the additional fibrous reinforcement.

The additional fibrous reinforcement comprises fibers positioned along an axis different from the longitudinal axis of the cylindrical element, preferably at an angle of between +/−10° and +/−89° with respect to the longitudinal axis of the cylindrical element, preferably, an angle of between +/−25° and +/−89° from the axis of the cylindrical element, more preferentially between +/−45° and +/−89°.

In other words, the longitudinal axis of the cylindrical element constitutes the 0° axis, and the direction of the fibers of the additional reinforcement constitutes a second axis. The angle between these two axes is as defined above. The +/− signs indicate whether the fibers of the additional fibrous reinforcement are positioned to the right or else to the left depending on the axis of the tube.

It has been observed that the deposition of a fibrous reinforcement in a different axis makes it possible to increase the resistance to internal pressure of the wall of the tube.

Preferably, a portion of the fibers included in the material of the cylindrical element is positioned in the longitudinal axis of the cylindrical element. More particularly, all of the fibers included in the material of the cylindrical element are positioned along the axis of the cylindrical element.

According to one embodiment, the tube can comprise a second cylindrical element composed of one or more layers of thermoplastic resin, not comprising fibers, also referred to as liner. This second cylindrical element can make it possible to increase the leaktightness of the tube. According to the application, it can also make it possible to increase the resistance to pressure of the tube, indeed even to reinforce the chemical resistance of the final part.

In other words, the tube according to the invention can comprise a liner, then, above, a cylindrical element as defined above, then an additional fibrous reinforcement as defined above.

The length and the diameter of the tube can be greater or smaller, depending on the application targeted.

Preferably, the tube according to the invention comprises:
one or more cylindrical elements, the fibers of which are positioned in the axis of the cylindrical element, and
one or more additional fibrous reinforcements, the fibers of which are positioned in an axis different from the axis of the cylindrical element.

According to a particularly preferred embodiment, the tube according to the invention comprises:
one or more cylindrical elements, the fibers of which are positioned in the axis of the cylindrical element, and
an additional fibrous reinforcement, the fibers of which are positioned at +/−89° with respect to the axis of the cylindrical element.

According to another embodiment, the tube according to the invention comprises:
one or more cylindrical elements, the fibers of which are a braid of dry fibers,
one or more additional fibrous reinforcements, the fibers of which are a braid of dry fibers positioned along an axis different from the axis of the braid of the cylindrical element.

The invention also relates to the process for the manufacture of the tube according to the invention. The process comprises the following successive stages:
a) pultrusion of the cylindrical element,
b) deposition of the additional fibrous reinforcement.

Preferably, it is a continuous process.

According to one embodiment, the stage of deposition of the additional fibrous reinforcement can be carried out by winding the tape of additional fibrous reinforcement around the cylindrical element. This deposition can be carried out under a certain mechanical stress so as to exert pressure on the cylindrical element.

Finally, the invention relates to the use of the tube according to the invention for forming structures, such as bicycle frames, reinforcements, more particularly battery pack reinforcements, vehicle chassis reinforcements, fishing rod elements, legs of movie camera or of cameras, photovoltaic panel supports, structures of camping elements, such as tent structures, ski poles, pipes for the transportation of fluids.

In other words, any structure of tubular shape can be produced from the tube according to the invention.

### DESCRIPTION OF THE FIGURE

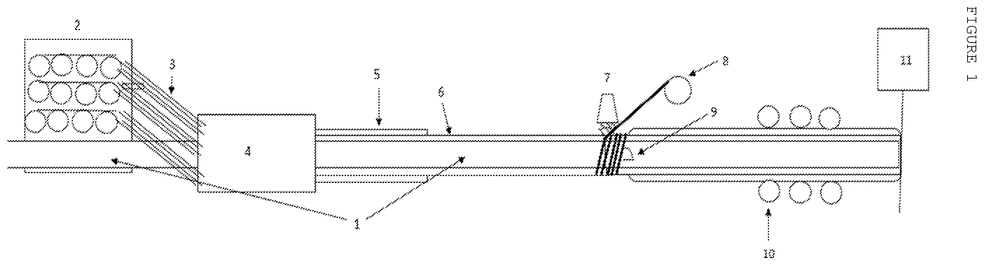

The process according to the invention can be illustrated by FIG. 1.

FIG. 1 illustrates a pultrusion process. The element 1 is an extruded tube, which will make it possible to give the shape to the final pultruded element. The dry fibers 3 leave the reels supported by the creel 2 and pass into the impregnation zone 4. This zone 4 comprises a bath of liquid resin or else a head for injection of the resin. The pultrusion die 5 guides the pultruded impregnated fibers resulting in the pultruded layer 6. The pultruded impregnated fibers undergo heating generated by a heating element 7. A reel 8 supports the additional fibrous reinforcement, which will be wound around the pultruded tube, according to an angle 9. The entire pultruded tube is pulled by pullers 10. The pultruded tube is subsequently cut by a cutting appliance 11.

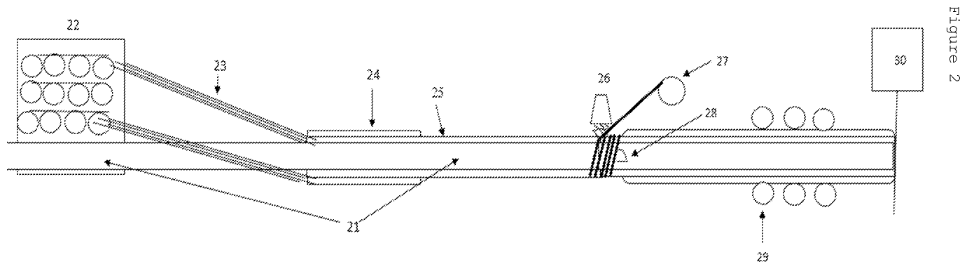

FIG. 2 illustrates another pultrusion process. The element 21 is an extruded tube, which will make it possible to give the shape to the final pultruded element. The fibers impregnated with resin 23 leave the reels supported by the creel 22 and pass into the pultrusion die 24. The latter guides the impregnated fibers and conforms them, resulting in the pultruded layer 25. The pultruded impregnated fibers undergo heating generated by a heating element 26. A reel 27 supports the additional fibrous reinforcement, which will be wound around the pultruded tube, according to an angle 28. The entire pultruded tube is pulled by pullers 29. The pultruded tube is subsequently cut by a cutting appliance 30.

### EXAMPLES

### Comparative Example

A composite tube, of circular section, exhibiting an external diameter of 50 mm and a thickness of 2 mm, is manufactured by pultrusion, at a rate of 0.5 m/min, by means of a melt impregnation process, using a tubular die connected to a single-screw extruder. The resin used for the pultrusion is a grade of polyamide 11 of low viscosity (reference Rilsan® FMNO) making it possible to obtain good impregnation of the fibers. This polyamide 11 resin exhibited an M.p. of 190° C. (measured according to the standard ISO 11357-3:2013) and the temperature in the pultrusion die was 250° C. The fibers used were Hypertex S4550 glass fibers sold by 3B. The fiber content was 58 vol % (fiber content with respect to the volume of the pultruded tube). The orientation of the fibers in the pultruded tube was exclusively along the axis of the tube.

The tube was tested in 3-point bending, at ambient temperature, with a space between supports of 1 m and a crosshead velocity of 1 mm/min: breaking occurred prematurely along the axis of the tube. The expression “premature breaking” is used because the tensile stress measured in the tube at the time of breaking was 550 MPa (table 1), i.e. about half of the expected theoretical value, which corresponds to breaking along the axis of the tube, that is to say a mode of breaking transverse to the fibers. This is explained by the absence of reinforcement perpendicular to the axis of the tube, making it possible to prevent this type of breaking transverse to the axis of the reinforcing fiber.

### Example 1

A composite tube of circular section, exhibiting an external diameter of 50 mm and a thickness of 2 mm, is manufactured by pultrusion, at a rate of 0.5 m/min, by means of a melt impregnation process, using a tubular die connected to a single-screw extruder. The resin used for the pultrusion is a grade of polyamide 11 of low viscosity (reference Rilsan® FMNO) making it possible to obtain good impregnation of the fibers. This polyamide 11 resin exhibited an M.p. of 190° C. (measured according to the standard ISO 11357-3:2013) and the temperature in the pultrusion die was 250° C. The fibers used were Hypertex S4550 glass fibers sold by 3B. The fiber content was 58 vol % (fiber content with respect to the volume of the pultruded tube). The orientation of the fibers in the pultruded tube was exclusively along the axis of the tube.

An additional reinforcement consisting of Hyosung H2550 G10 carbon fibers not impregnated with resin (i.e., dry fibers reinforcement) was wound at 85° from the axis of the tube, over a thickness of 1 mm.

The composite tube obtained was tested in three-point bending, at ambient temperature, with a space between supports of 1 m and a crosshead velocity of 1 mm/min: the stress measured was 800 MPa: the presence of the additional reinforcing fibers makes it possible to delay the breaking transverse to the fibers of the pultruded tube but does not eliminate it.

### Example 2

A composite tube exhibiting an external diameter of 170 mm and a thickness of 2 mm is manufactured by pultrusion, at a rate of 0.5 m/min, by means of a melt impregnation process, using a tubular die connected to a single-screw extruder. The resin used for the pultrusion is a grade of polyamide 11 of low viscosity (reference Rilsan® FMNO) making it possible to obtain good impregnation of the fibers. This polyamide 11 resin exhibited an M.p. of 190° C. (measured according to the standard ISO 11357-3:2013) and the temperature in the pultrusion die was 250° C. The fibers used were Hypertex S4550 glass fibers sold by 3B. The fiber content was 58 vol % (fiber content with respect to the volume of the pultruded tube). The orientation of the fibers the pultruded tube was exclusively along the axis of the tube.

An additional fibrous reinforcement, consisting of a composite tape with a width of ½″, was wound perpendicular to the axis of the tube (given the width of the tape and the diameter of the pultruded tube, the angle of the fibers was approximately 85°) over a thickness of 1 mm. The composite tape was composed of a Hyosung H2525 G10 carbon fiber which were impregnated with a resin of polyamide 11 type (reference Rilsan® FMNO) exhibiting a glass transition temperature of 50° C. (measured by DSC according to the standard ISO 11357-2:2013). The fiber content was 55% by volume (with respect to the volume of the composite tape). The composite tape was employed by means of an automatic deposition process with laser heating of Coriolis® Solo brand, at a temperature of 270° C. and a rate of 0.3 m/s.

The composite tube obtained was tested in 3-point bending, at ambient temperature, with a space between supports of 1 m and a crosshead velocity of 1 mm/min: the stress measured was 1000 MPa. Breaking in transverse mode with regard to the fibers of the pultruded tube is completely eliminated. Breaking is then perpendicular to the axis of the tube and thus to the axis of the fibers of the tube: it is then said that the mode of breaking is axial.

### Example 3

A composite tube, of circular section, exhibiting an external diameter of 170 mm and a thickness of 2 mm, is manufactured by pultrusion, at a rate of 0.5 m/min, by means of a melt impregnation process, using a tubular die connected to a single-screw extruder. The resin used for the pultrusion is a grade of polyamide 11 of low viscosity (reference Rilsan® FMNO) making it possible to obtain good impregnation of the fibers. This polyamide 11 resin exhibited an M.p. of 190° C. (measured according to the standard ISO 11357-3:2013) and the temperature in the pultrusion die was 250° C. The fibers used were Hypertex S4550 glass fibers sold by 3B. The fiber content was 58 vol % (fiber content with respect to the volume of the pultruded tube). The orientation of the fibers in the pultruded tube was exclusively along the axis of the tube.

An additional fibrous reinforcement, consisting of a composite tape with a width of ½″, was wound perpendicular to the axis of the tube (given the width of the tape and the diameter of the pultruded tube, the angle of the fibers was approximately 85°) over a thickness of 1 mm. The composite tape was composed of a Hyosung H2525 G10 carbon fiber which were impregnated with a resin of PPA 11/BACT/10T type exhibiting a glass transition temperature of 140° C. (measured by DSC according to the standard ISO 11357-2:2013). The fiber content was 55% by volume (with respect to the volume of the composite tape). The composite tape was employed by means of an automatic deposition process with laser heating of Coriolis® Solo brand, at a temperature of 330° C. and a rate of 0.3 m/s.

The composite tube obtained was tested in bending, at ambient temperature, with a space between supports of 1 m and a crosshead velocity of 1 mm/min: the stress measured was 1200 MPa. Breaking in transverse mode with regard to the fibers of the pultruded tube is completely eliminated; the mode of breaking is axial.

TABLE 1
Summary of the results

| | | Bending | |
|---|---|---|---|
| | Type of additional | stress/ | |
| | reinforcement | [MPa] | Mode of breaking |
| Comparative | nothing | 550 | Transverse (along the |
| example | | | axis of the tube) |
| Example 1 | Dry Hyosung 2550 G10 | 800 | Transverse (along the |
| | carbon fibers | | axis of the tube) |
| Example 2 | Composite tape PA11 | 1000 | Axial (perpendicular to |
| | H250 G10 carbon | | the axis of the tube) |
| Example 3 | Composite tape | 1200 | Axial (perpendicular to |
| | 11/BACT/10T H250 G10 | | the axis of the tube) |
| | carbon | | |

1. A tube comprising:
at least one cylindrical element made of a pultruded fibrous material impregnated with a thermoplastic matrix,
at least one additional fibrous reinforcement, partially or completely surrounding the cylindrical element(s),
the fibers contained in the additional fibrous reinforcement being positioned along an axis different from the longitudinal axis of the cylindrical element,
the total content of fibers of the tube being of between 40% and 70% by volume, with respect to the volumes of the matrix and of the fibers contained in the tube.

2. The tube as claimed in claim 1, wherein the additional fibrous reinforcement is chosen from dry continuous fibers, a fibrous material based on continuous fibers impregnated with a thermoplastic matrix, and their mixture.

3. The tube as claimed in claim 1, wherein the additional fibrous reinforcement comprises fibers positioned at an angle of between +/−10° and +/−89° with respect to the axis of the cylindrical element.

4. The tube as claimed in claim 1, wherein a portion of the fibers included in the material of the cylindrical element is positioned in the longitudinal axis of the cylindrical element.

5. The tube as claimed in claim 1, wherein the additional fibrous reinforcement is chosen from a braid of dry fibers, a braid of fibrous tapes impregnated with thermoplastic resin, and their mixture.

6. The tube as claimed in claim 1, wherein the fibers used to manufacture the pultruded fibrous material of the cylindrical element are a braid of dry fibers.

7. The tube as claimed in claim 2, wherein the thermoplastic matrix of the cylindrical element is completely or partially miscible with the thermoplastic matrix of the additional fibrous reinforcement.

8. The tube as claimed in any one claim 2, wherein the thermoplastic matrix of the additional fibrous reinforcement exhibits a melting point of greater than 150° C. and/or a glass transition temperature of greater than 80° C.

9. The tube as claimed in claim 1, wherein it comprises, inside the cylindrical element, a second cylindrical element composed of one or more layers of thermoplastic resin, not comprising fibers.

10. The tube as claimed in claim 1, wherein the thermoplastic matrix predominantly contains a thermoplastic polymer or a blend of thermoplastic polymers.

11. The tube as claimed in claim 10, wherein the thermoplastic polymer is chosen from poly(aryl ether ketone)s (PAEKs); poly(aryl ether ketone ketone)s (PAEKKs); aromatic polyetherimides (PEIs); polyaryl sulfones; polyaryl sulfides; polyamides (PAs); PEBAs, the M.p. of which is greater than 150° C.; polyacrylates; polyolefins, with the exclusion of polypropylene; polylactic acid (PLA); polyvinyl alcohol (PVA); fluoropolymers; polyvinyl chloride (PVC); and acrylonitrile-butadiene-styrene (ABS) polymer; and their blends.

12. The tube as claimed in claim 10, wherein the thermoplastic polymer is chosen from polyamides, aliphatic polyamides, cycloaliphatic polyamides and semiaromatic polyamides (polyphthalamides), PEKK, PEI, and a blend of PEKK and of PEI.

13. The tube as claimed in claim 10, wherein the thermoplastic polymer is chosen from aliphatic polyamides, cycloaliphatic polyamides, and semiaromatic polyamides (polyphthalamides).

14. The tube as claimed in claim 10, wherein the thermoplastic polymer is chosen from polyamide 6 (PA6), polyamide 11 (PA11), polyamide 12 (PA12), polyamide 66 (PA66), polyamide 46 (PA46), polyamide 610 (PA610), polyamide 612 (PA612), polyamide 1010 (PA1010), polyamide 1012 (PA1012), polyamide 11/1010 (PA11/1010) and polyamide 12/1010 (PA12/1010), or a blend of these or a copolyamide of these.

15. The tube as claimed in claim 10, wherein the thermoplastic polymer is chosen from a semiaromatic polyamide of formula A/XT in which:
A is chosen from a unit obtained from an amino acid, a unit obtained from a lactam and a unit corresponding to the formula (Ca diamine)·(Cb diacid), with a representing the number of carbon atoms of the diamine and b representing the number of carbon atoms of the diacid, a and b each being of between 4 and 36, the (Ca diamine) unit being chosen from linear or branched aliphatic diamines, cycloaliphatic diamines and alkylaromatic diamines and the (Cb diacid) unit being chosen from linear or branched aliphatic diacids, cycloaliphatic diacids and aromatic diacids;
XT denotes a unit obtained from the polycondensation of a Cx diamine and of terephthalic acid, with x representing the number of carbon atoms of the Cx diamine, x being of between 6 and 36.

16. The tube as claimed in claim 15, wherein the thermoplastic polymer is chosen from a semiaromatic polyamide of formula A/6T, A/9T, A/10T or A/11T; T corresponds to terephthalic acid.

17. The tube as claimed in claim 10, wherein the fibrous material is chosen from glass fibers, carbon fibers, basalt fibers, and basalt-based fibers.

18. The tube as claimed in claim 1, wherein the content of fibers in said impregnated fibrous material is of from 45% to 70% by volume, with respect to the volume of the impregnated fibrous material.

19. The tube as claimed in claim 1, wherein the total content of fibers is of between 40% and 70% by volume, with respect to the sum of the volume of the matrix and of the fibers.

20. A process for the manufacture of the tube as defined in claim 1, the process comprising the following successive stages:
a) pultrusion of the cylindrical element,
b) deposition of the additional fibrous reinforcement.

21. The process as claimed in claim 20, wherein the stage of deposition of the additional fibrous reinforcement is carried out by winding the tape of additional fibrous reinforcement around the cylindrical element.

22. The process as claimed in claim 22, wherein said deposition is carried out under a certain mechanical stress so as to exert pressure on the cylindrical element.

23. A method of using the tube as defined in claim 1 for forming structures, reinforcements, vehicle chassis reinforcements, fishing rod elements, legs of movie camera or of cameras, photovoltaic panel supports, structures of camping elements, ski poles, pipes for the transportation of fluids.
